(19) United States
(12) Patent Application Publication
(10) Pub. No.: US 2011/0247171 A1
(43) Pub. Date: Oct. 13, 2011

(54) Eraselet - Bracelet Eraser

(75) Inventor: Bryan Ricci, Goodlettsville, TN (US)

(73) Assignee: THE ERASELET COMPANY LLC, Goodlettsville, TN (US)

(21) Appl. No.: 12/756,356

(22) Filed: Apr. 8, 2010

(51) Int. Cl. B43L 19/00

(52) U.S. Cl. 15/424

(57) ABSTRACT

An eraser comprised of a band of vulcanized silicone rubber, to be worn on a human wrist, capable of erasing marks, such as pencil and pen markings from a surface.

### BACKGROUND OF THE INVENTION

1. Field of the Invention

The present invention relates generally to erasers and more specifically to erasers in the form of silicone rubber bands and/or silicone rubber jewelry, namely bracelets.

2. Background Art

Erasers and the like have been known. Erasers are typically constructed of rubber or synthetic material that allow a user to erase a mark, such as a pencil mark, ink mark, the like, or indicia from a surface. Erasers typically have a rubbery consistency, come in a variety of colors, and are comprised of a single layer of material, such as synthetic rubber, plastic or gum-like materials, synthetic soy-based gum, and may also contain vinyl and pulverized pumice.

Edward Naime, an English engineer, is credited with creating the first rubber eraser, using natural rubber, in 1770. However, such natural rubber erasers were not durable, were perishable, and would go bad over time. Erasers came into common use after Charles Goodyear discovered the process of vulcanization in 1839, a method that cured rubber and made it durable. Hymen Lipman received the first patent on Mar. 30, 1858 (U.S. Pat. No. 19,783) for attaching an eraser to the end of a pencil; however, the patent was later invalidated.

Erasers come in several shapes and sizes; the more common erasers come attached to pencils, conical cap erasers that may be slipped onto the ends of pencils, block and wedge erasers that may be rectangular or block shaped, and barrel erasers contained in a barrel of a retractable cylinder. Novelty erasers are also available that have a variety of colors, shapes, and designs that are primarily intended for their decorative nature more than practical use.

Erasers that may be used for instructional purposes and/or entertainment and that may be used practically for the function of erasing are necessary. Such erasers should have the added convenience and capability of being worn, as jewelry, on or close to the human hand and therefore close to the writing utensil providing marks that may need erasing.

The solution for this lack of convenience and practicality is the invention of an “eraselet,” an eraser made of silicone rubber with an open circular form that may be worn loosely, as jewelry, around the human wrist.

U.S. Pat. No. 6,547,465 (Rago, et al.) discloses a pencil that has a fixed non-replaceable eraser and a moveable sleeve.

U.S. Pat. No. 5,709,491 (Yeh) discloses a tubular eraser for erasing ink or pencil marks comprising an elongated body of a rubber material.

U.S. Pat. No. 4,899,419 (Saleen) discloses a pencil eraser assembly having elongated hollow eraser sleeve formed to align in elemental parallel spaced relationship with both a frustum shaped segment and a portion of a cylindrical barrel segment of a pencil.

U.S. Pat. No. 4,689,858 (Barber) discloses a fastening device comprised of an elastic band permanently attached at one end either in a utilitarian sense or in a static sense and temporarily attached at the other end, of which is adjustable by pulling on this unattached end, to a simple clasp with holes of a similar diameter as the elastic band and of which secures the band to a specific total circumference and range of tensile strength by the force of friction generated between the band and clasp.

For the foregoing reasons, there is a need for silicone rubber erasers with the added convenience and capability of being worn, as jewelry, on or close to the human hand and therefore close to the writing utensil providing marks that may need erasing.

### SUMMARY

The present invention is directed to an eraser in the form of a silicone rubber band and/or silicone rubber jewelry, namely a bracelet.

Eraselets®, erasers produced in the form of a circular, silicone rubber band and/or silicone rubber jewelry, have elasticity as to not be constricted in form to assist in pulling the Eraselet® over the hand to the wrist were such erasers should be worn and to assist in removing the Eraselet® from the wrist, back over the hand for removal.

Eraselets® have elasticity so that the persons using this eraser can simply stretch the device from their wrist toward the tips of their fingers, to be gripped between their thumb and forefinger or to rest over the ball of their thumb, to make erasing marks, such as pencil and pen markings, more convenient.

Eraselets® can be used in the same manor as traditional bar or wedge erasers; erasing marks, such as pencil and pen markings, by simply holding the present invention in the hand and rubbing out such markings from a surface.

Every part of an Eraselet® may be used to erase a mark, such as a pencil mark, ink mark, the like, or indicia from a surface.

Minimal amounts of dust amass from the use of this form of eraser, making it more environmentally efficient than traditional erasers.

Furthermore, no PVC plastics are used in the production of this eraser, making it more environmentally efficient than some erasers currently in production.

Eraselets® are not consistent in design and can be made in various colors, shapes, objects, patterns, textures, and the combination thereof.

Objects may be in the form of any person, place, or thing.

Injection molds are the most common method used to manufacture silicone rubber based products. Eraselets® are formed by injecting vulcanized silicone rubber into a set mold. Once the silicone rubber has been shaped, a 4-24 hour curing process is required before an Eraselet® is ready for individual use.

### DRAWINGS

These and other features, aspects, and advantages of the present invention will become better understood with regard to the following description, appended claims, and accompanying drawings where:

FIG. 1 is a perspective view of an Eraselet®, showing its circular form, constructed in accordance with the present invention, which shows an outermost layer of the Eraselet®;

FIG. 2 is a perspective view of FIG. 1, showing the Eraselet® from a vertical stance providing further detail of the present invention;

FIG. 3 is a perspective view of FIG. 1, showing the Eraselet® from a separate vertical stance than FIG. 2 yet still detailing the basic structure of the present invention in the same format as FIGS. 1 and 2;

FIG. 4 is a side view of FIG. 1, showing the innermost view of Eraselet®;

FIG. 5 is a top view of an Eraselet® worn the wrist of a hand; the wrist and hand shown in phantom.

### DESCRIPTION

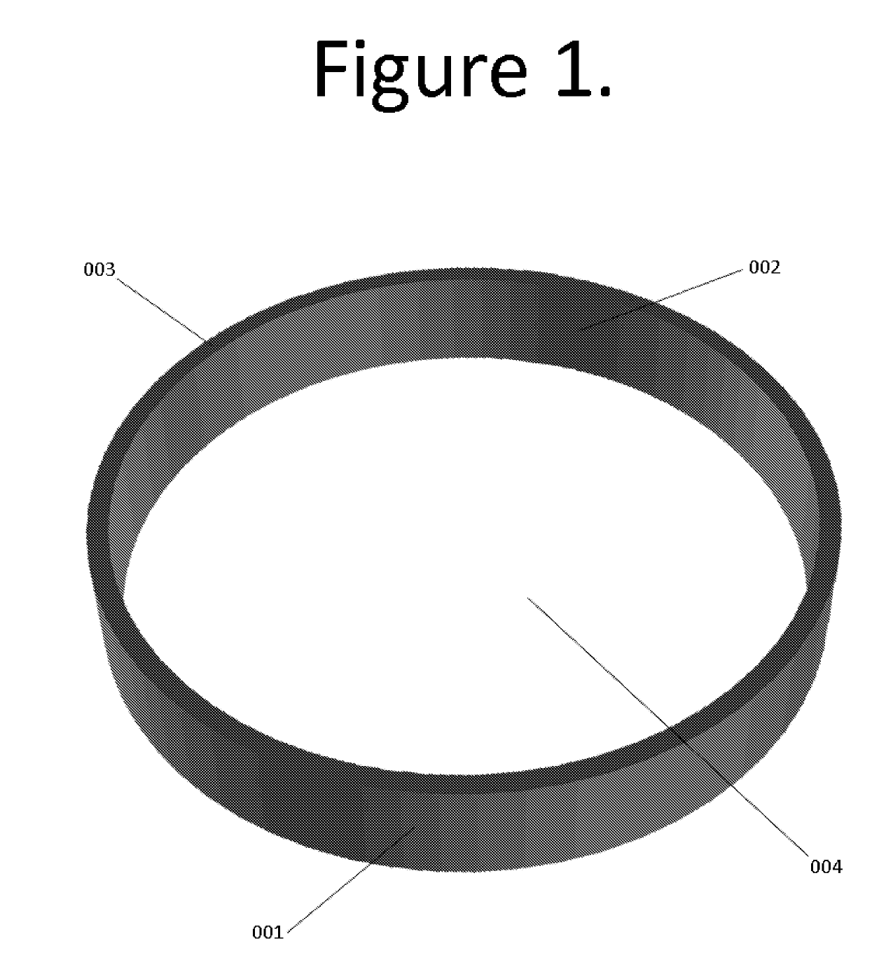

The preferred embodiments of the present invention will be described with reference to FIGS. 1-5 of the drawings. Identical elements in the various figures are identified with the same reference numbers.

FIGS. 1-5 shows embodiments of the present invention, which is a silicone rubber band and/or silicone rubber jewelry, namely a bracelet. In the embodiments shown, each silicone rubber band and/or silicone rubber bracelet has a single layer, although other suitable layers may be used. The Eraselet® may have one or more layers comprised of silicone rubber, depending upon the process selected for manufacturing and design purposes.

An Eraselet® has an opening between all sides and is adapted to be worn on the human wrist.

FIG. 1 reference 001 shows, what could be considered, the outermost surface of the Eraselet®, from a top horizontal perspective.

FIG. 1 reference 002 shows, what could be considered, the innermost surface of the Eraselet®, from a top horizontal perspective.

FIG. 1 reference 003 shows, what could be considered, one of two side surfaces, as well as the innermost construction of the Eraselet®, from a top horizontal perspective.

FIG. 1 reference 004 shows an opening between all sides of the Eraselet® for adaptation of the Eraselet® to be worn on the human wrist

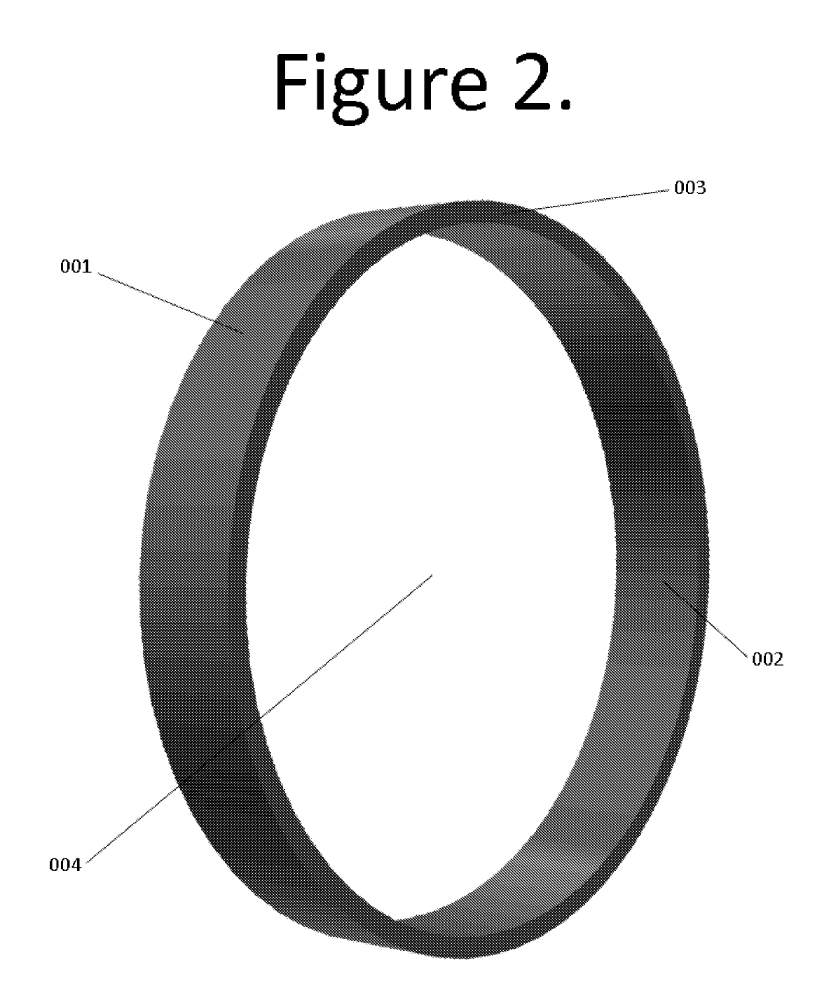

FIG. 2 reference 001 shows, what could be considered, the outermost surface of the Eraselet®, from a left vertical perspective.

FIG. 2 reference 002 shows, what could be considered, the innermost surface of the Eraselet®, from a left vertical perspective.

FIG. 2 reference 003 shows, what could be considered, one of two side surfaces, as well as the innermost construction of the Eraselet®, from a left vertical perspective.

FIG. 2 reference 004 shows the same opening, as referenced in FIG. 1 reference 004, from a left vertical perspective.

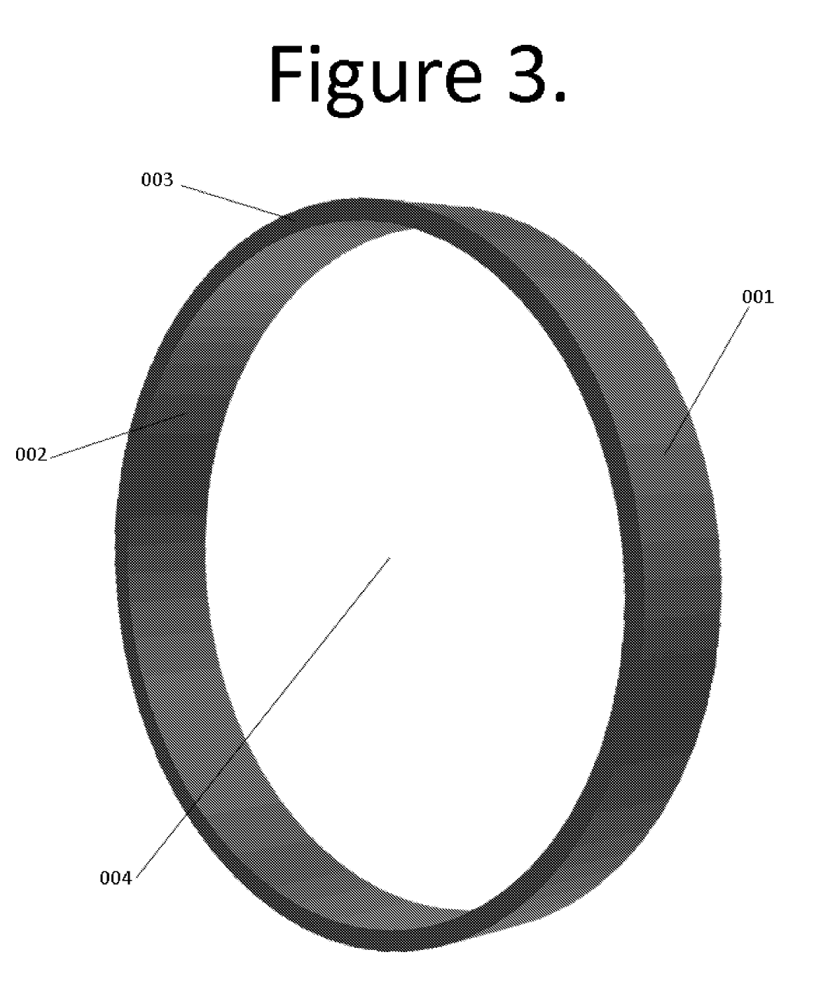

FIG. 3 reference 001 shows, what could be considered, the outermost surface of the Eraselet®, from a right vertical perspective.

FIG. 3 reference 002 shows, what could be considered, the innermost surface of the Eraselet®, from a right vertical perspective.

FIG. 3 reference 003 shows, what could be considered, one of two side surfaces, as well as the innermost construction of the Eraselet®, from a right vertical perspective.

FIG. 3 reference 004 shows the same opening, as referenced in FIGS. 1 and 2 reference 004, from a right vertical perspective.

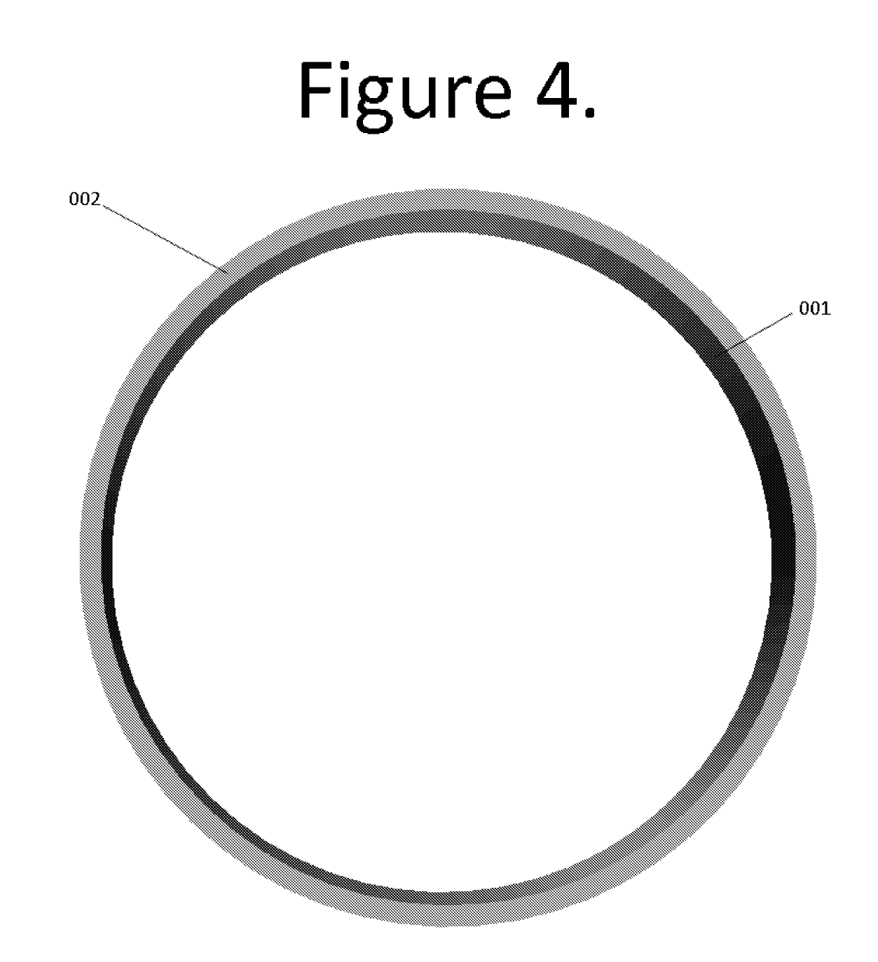

FIG. 4 reference 001 shows a continuous surface of an Eraselet®, where the entire surface is comprised of vulcanized silicone rubber. This reference also shows how the continuous surface, mentioned previously in this paragraph, when coupled with the silicone surface shown in FIG. 4 reference 002 equals an eraser in the form of a band comprised of vulcanized silicone rubber.

FIG. 4 reference 002 shows, what could be considered the side surface of an Eraselet®, comprised of vulcanized silicone rubber. This reference also shows how the continuous surface, mentioned previously in this paragraph, when coupled with the silicone surface shown in FIG. 4 reference 001 equals an eraser in the form of a band comprised of vulcanized silicone rubber.

Each surface extends to the center of the Eraselet® meeting the other surfaces of the Eraselet® to comprise a continuous band made of silicone rubber.

Every surface of the Eraselet® has the capability of erasing marks, such as pencil and pen markings by rubbing silicone rubber surfaces against said marks until marks disappear.

Surfaces of the Eraselet® are not constricted by shape and size; An Eraselet® can be made in the form of a continuous rectangle that forms a band, as well as a continuous circle that forms a band, as well any other various shapes that may be conceivable to form a band.

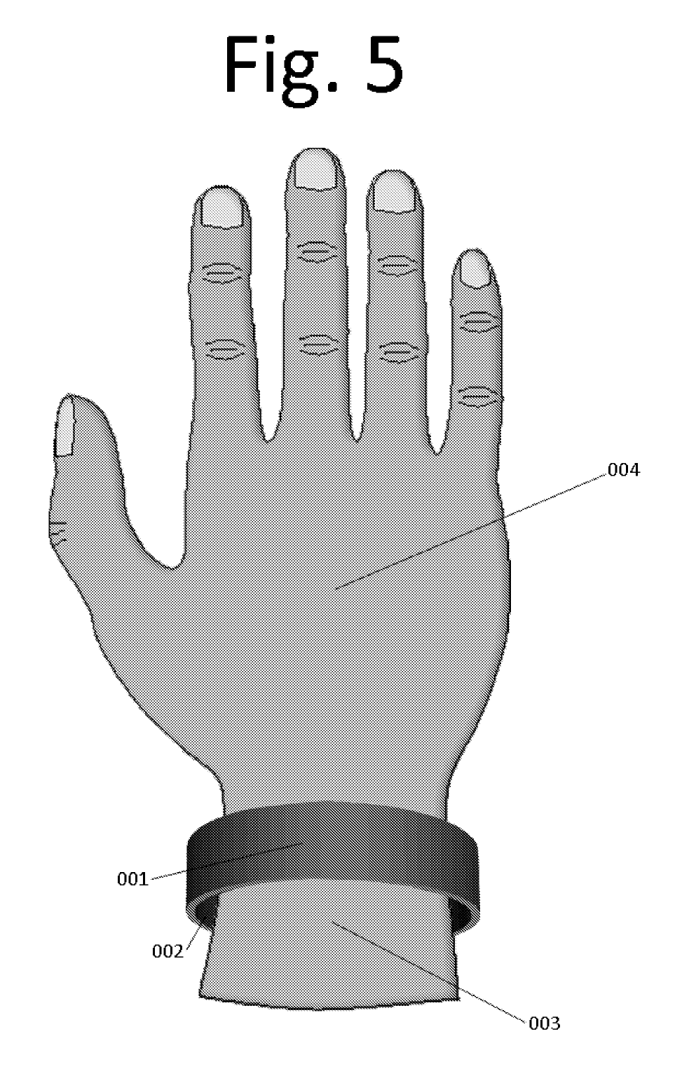

FIG. 5 shows how the Eraselet is adapted to be worn on the human wrist.

FIG. 5 reference 001 shows, what could be considered the outermost surface of an Eraselet® while being worn on a phantom wrist located below a phantom hand. In this instance the “outermost surface” coupled with the other surfaces, referenced in FIG. 5 comprise the functional parts of the present invention as described in paragraphs 0046 and 0047.

FIG. 5 reference 002 shows, what could be considered the innermost surface of an Eraselet®. In this instance, the “innermost surface” is in partial contact with the wrist at all times; surrounding the wrist in circumference while being held in place, marginally between the forearm, FIG. 5 reference 003, and the hand, FIG. 5 reference 004.

What is claimed:

1. An Eraselet®, comprising: a band, made of vulcanized silicone rubber, capable of erasing marks, such as pencil and pen markings by rubbing out such markings from a surface.

2. The Eraselet® according to claim 1, wherein: said Eraselet® is adapted to be worn on a human wrist.

3. The Eraselet® according to claim 1, wherein: said Eraselet® has elasticity.
